(19) United States
(12) Patent Application Publication
(10) Pub. No.: US 2005/0004843 A1
(43) Pub. Date: Jan. 6, 2005

(54) System and method for providing restaurant related services

(76) Inventor: Steven S. Heflin, Foxborough, MA (US)

Correspondence Address: LOWRIE, LANDO & ANASTASI, RIVERFRONT OFFICE, ONE MAIN STREET, ELEVENTH FLOOR, CAMBRIDGE, MA, 02142, US

(21) Appl. No.: 10/612,268

(22) Filed: Jul. 1, 2003

(51) Int. Cl. G06F 17/60

(52) U.S. Cl. 705/15

(57) ABSTRACT

The use of a network to integrate multiple unaffiliated restaurants, inventory databases associated with the restaurants, and customer records with a delivery mechanism through the use of a common network portal is disclosed. The illustrative embodiment of the present invention allows a registered customer to order from one of multiple unaffiliated restaurants over a network. Customer account information including location and billing information as well as dietary restriction information is stored at a network accessible location during a registration process. The individual restaurants post menus listing the various menu items available for purchase from the restaurant. The menu items are accompanied by associated dietary information. The dietary information may be cross-referenced with any dietary restrictions specified by the customer in the stored customer record. The orders are processed using the recorded billing information from the stored customer record. An integrated database programmatically updates an inventory to reflect the ingredients used in the ordered items. The preparation status of the order is available to the customer over the network. A delivery service provider is also interfaced with the network and delivers orders for more than one of the unaffiliated restaurants. The delivery service provider also has access to the preparation status and picks up the order upon completion. Thereafter, the customer has access to delivery status information that is provided over the network indicating a periodically updated current location of the delivery and/or estimate of the time of arrival for the order at the customer's location.

### FIELD OF THE INVENTION

The illustrative embodiment of the present invention relates generally to the delivery of restaurant related services, and more particularly to the use of a network to integrate multiple unaffiliated restaurants, inventory databases associated with the restaurants, and customer records, with a delivery mechanism through the use of a common network portal.

### BRIEF SUMMARY OF THE INVENTION

The illustrative embodiment of the present invention allows a registered customer to order from one of multiple unaffiliated restaurants over a network. Customer account information including location and billing information as well as dietary restriction information is stored at a network accessible location during a registration process. The individual restaurants post menus listing the various menu items available for purchase from the restaurant. The menu items are accompanied by associated dietary information. The dietary information may be cross-referenced with any dietary restrictions specified by the customer in the stored customer record. The orders are processed using the recorded billing information from the stored customer record. Following the approval of the order, the individual restaurant begins preparation of the order. An integrated database programmatically updates an inventory to reflect the ingredients used in the ordered items. The preparation status of the order is available to the customer over the network. A delivery service provider is also interfaced with the network and delivers orders for more than one of the unaffiliated restaurants. The delivery service provider also has access to the preparation status and picks up the order upon completion. Thereafter, the customer has access to delivery status information that is provided over the network indicating a periodically updated current location of the delivery and/or estimate of the time of arrival for the order at the customer's location.

### BRIEF DESCRIPTION OF THE DRAWINGS

FIG. 1 is a block diagram of an environment suitable for practicing the illustrative embodiment of the present invention;

FIG. 2 is a flowchart of the sequence of steps followed by the illustrative embodiment of the present invention to allow a customer to order restaurant services over the network;

FIG. 3 is a flow chart of the sequence of steps followed by the illustrative embodiment of the present invention to integrate delivery services into the food preparation process;

FIG. 4 is a flow chart of the sequence of steps followed by the illustrative embodiment of the present invention to provide the preparation status of an order to the customer and delivery service provider; and

FIG. 5 is a flow chart of the sequence of steps followed by the illustrative embodiment of the present invention to integrate an inventory with the ordering process.

### DETAILED DESCRIPTION

The illustrative embodiment of the present invention enables a customer to order over a network from one of multiple non-affiliated restaurants. The restaurants voluntarily agree to share access from a common network site administered by a Restaurant Services Application. The restaurants provide their own individual menus and menu items along with associated information for display to an ordering customer over the network. The restaurants may integrate a database holding their menu item ingredient inventory with the ordering system. After a customer selects menu items, billing information is processed, and the restaurants receive notification of the order. Any integrated ingredient inventory associated with the preparing restaurant is programmatically updated. Customers can track the preparation status of their order over the network. Additionally, delivery providers who have agreed to service the multiple restaurants and provide delivery services to specified locations are also interfaced with the location holding the Restaurant Services Application. The delivery service providers track the preparation status of the order and pick the order up upon its completion. Thereafter, the delivery service provider provides periodic updates over the network indicating their current location and/or an estimated time of delivery. The customer is is thus able to track the estimated time of delivery while it changes over the network.

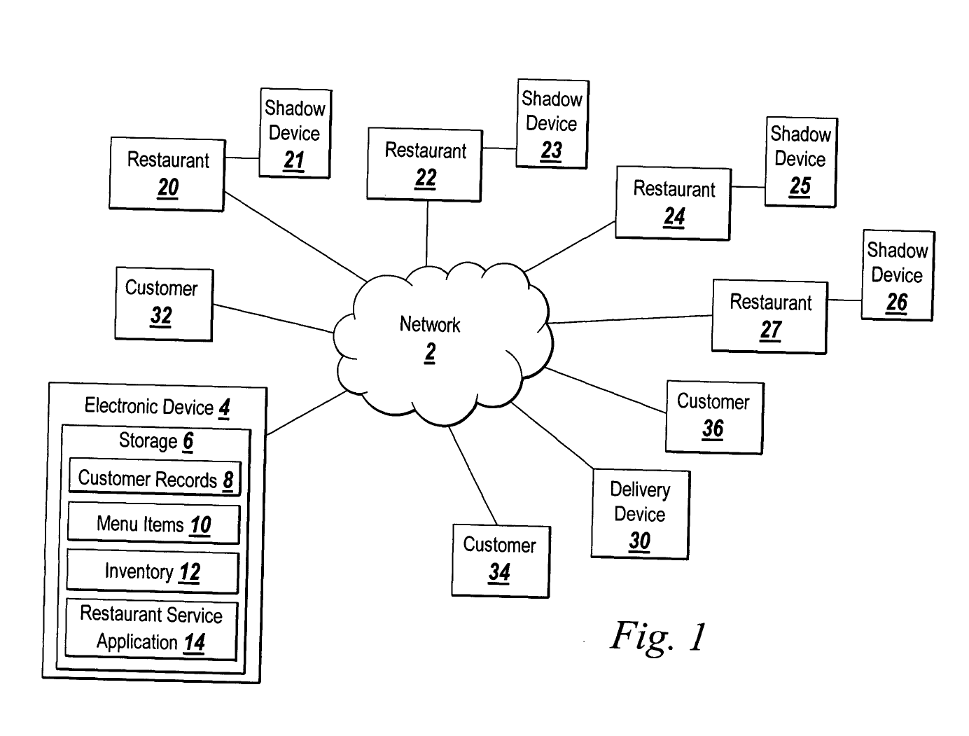

FIG. 1 depicts a block diagram of an environment suitable for practicing the illustrative embodiment of the present invention. Multiple restaurants, 20, 22, 24, and 26, are interfaced with a network 2. The network 2 in most implementations will be the Internet, but may also be a wide area network (WAN), local area network (LAN) or some other type of network. Also interfaced with the network is an electronic device 4. The electronic device 4 may be a server, workstation, mainframe, or other electronic device equipped with a processor. The electronic device 4 includes storage 6. The storage 6 includes customer records 8, menu items 10 and a Restaurant Services Application 14. The customer records 8 hold customer records for a plurality of customers 32, 34, and 36. The customer record information includes customer ID's, billing information, and dietary restriction information which the customer desires to have recorded. The use of the dietary restriction information will be discussed further below. The menu items 10 are provided by the plurality of unaffiliated restaurants 20, 22, 24, and 26. Each menu item includes associated preparation options. The preparation options include cooking time (e.g.: rare, medium, well done) and side dishes (e.g.: baked potato). The Restaurant Services Application 14 enables customer access to the menu items 10. Also included on the electronic device 4 is an inventory 12 segmented by the various restaurants 20, 22, 24, and 26. The inventory 12 holds the ingredients used by each of the restaurants to prepare the plurality of menu items 10 and is constantly being updated by the Restaurant Services Application 14. Upon an order being received and processed, the restaurant 20, 22, 24, and 26 is informed of the accepted status of the order and begins preparation of the order. The Restaurant Services Application 14 then cross-references the ingredients used to prepare the menu item, and the amounts of the ingredients used to make the ordered menu items with the inventory 12 of the preparing restaurant. While reference is made herein to the restaurants 20, 22, 24 and 26 being unaffiliated, the restaurants may be affiliated (such as having a common owner or being members of the same chain of restaurants) without departing from the scope of the present invention. Similarly, the Restaurant Services Application 14 may be comprised of multiple programs and pieces of executable code integrated together.

Those skilled in the art will recognize there are many possible implementations of the different software components utilized by the illustrative embodiment of the present invention. For example the inventories 12 may be stored at electronic devices running at the various restaurant locations instead of being stored on the electronic device 4. In such an implementation, the Restaurant Service Application 14 would then access the locally stored inventory over the network rather than accessing the inventory locally. Similarly, the customer records 8 and menu items 10 may be stored at separate network accessible locations interfaced with the network 2, rather than on the electronic device 4 holding the Restaurant Services Application 14. In one implementation, each of the restaurants includes a shadow device 21, 23, 25 and 27 which includes mirror copies of all the information being processed by the Restaurant Services Application 14. The purpose of the shadow device 21, 23, 25, and 27 is to allow the continued processing of food orders in the event of a loss of network connectivity.

The illustrative embodiment of the present invention is comprised of a combination of programs written in C++, php and perl scripts, XML, XSTL, and CSS. The software implements control and automation for all areas of a restaurant's operation. The Restaurant Services Application 14 can control and coordinate several restaurants and delivery businesses all from a single computer. Standard Internet technology and software components in the public domain may be used which allows the use of a wide range of standard hardware components. Restaurant owners and customers can use equipment they are familiar with and already own. Since low cost commodity items are used for the system components, the overall system costs significantly less than conventional restaurant control systems.

The storage 6 may be implemented as a standard SQL database containing all the information from which the system operates. The SQL platform is configured to be “transaction safe”, meaning that the platform protects itself from transactions getting partially entered into the database. Partially entered transactions occur in non-compliant engines when a power or hardware failure occurs in the middle of a database entry. The database holds a number of tables such as:

Customer—each record in the Customer Table may be created when a customer creates an account on the system. Each record stores a customer's name, secret password, and current address and phone number, along with the credit card billing information. In addition, the customer is provided with an area to enter dietary information, such as ingredients they are allergic to, or a watch on calories, salt or fat.

Restaurant—each record in the Restaurant Table may be created when a restaurant joins the service. It contains the access information that allows the administration staff and chef to create menus and inventory records, set prices and availability of items, and enter ingredient information.

Menu Group—contains the list of group names that appear on the menu, and the order they are to appear in. For example most restaurants will have a group “Appetizers” and make it group number one so it appears first.

Menu Item—contains a record for each item on each menu. In addition to the item name, description, price, and quantity available, a picture can be associated. A group ID and list order number determines where the item gets drawn on the menu. Small items used for options on other items (bacon bits for example), can be omitted from the display of the menu by setting the group ID to zero. A field “Short Name” contains the abbreviated name used to build the display that appears on the order.

Menu Option—contains a record for each option that is offered on the menu. There are two styles of options available, one where only a single item must be selected, and one where multiple choices can be selected. For example, “Cooked” is an option used for steak, prime rib, or hamburger items, and only one choice can be selected. “Potato Toppings” is an example of an option where multiple choices can be made.

Menu Option Choices—contains a record for each choice available on each Menu Option. A choice can either be a preparation style, or a material item. For the “Cooked” option example above, five associated records would be entered into the Choice Table, “Rare”, “Medium Rare”, “Medium”, “Medium Well”, and “Well Done”. In the “Potato Toppings” example, several associated records are entered into the Choices table, “American Cheese”, “Bacon Bits” for example, and each choice is linked to a Menu Item. This technique allows the system to include the options in the calorie calculations, and control the inventory down to the last detail.

Menu Item Option—contains the associations between Menu Items and Menu Options. Any number of options can be given to a Menu Item by entering a record into this table with the ID of Menu Item and the ID of the Menu Option. An “Option Number” parameter exists in each record, used to control the order that the options are displayed. Options are processed from the lowest number to the highest. For example, a steak might have two options, “Cooked” and “Choice of Potato”. By making the Option Number of “Cooked” a lower number than “Choice of Potato”, the display result is the way the kitchen wants it. For example “T-Bone rare mashed” would be displayed in the kitchen.

Inventory—contains a record for each ingredient. Each record contains the name, quantity on hand, units of measure, and an ID. Ingredient—contains the associations between menu items and inventory. Any number of ingredient records can be entered for each menu item, by adding records with the ID of the menu item, the ID of the inventory item, and the amount required. The system uses this association to calculate nutritional information and to alert customers if an item contains an ingredient they are allergic to.

Vendors—contains a record for each vendor that the restaurant buys inventory from.

Inventory Vendor—contains the association between each inventory item and the vendor from which it can be purchased. Any number of vendors can be specified for a given inventory item by entering a record with the Inventory ID of the item, the ID of the Vendor, and the price that vendor charges for a specified amount of the item.

Orders—contains all the orders for each restaurant. The record contains all the control fields that the system uses to process and track the order.

Order Item—contains the list of menu items on each order. The order ID field associates the Order Item with a particular order in the previous table.

Delivery Driver—contains the contact information for each driver, and the coordinates of the area that they service.

Those skilled in the art will recognize that other versions of these tables and other types of tables may also be contained with the database without departing from the scope of the present invention.

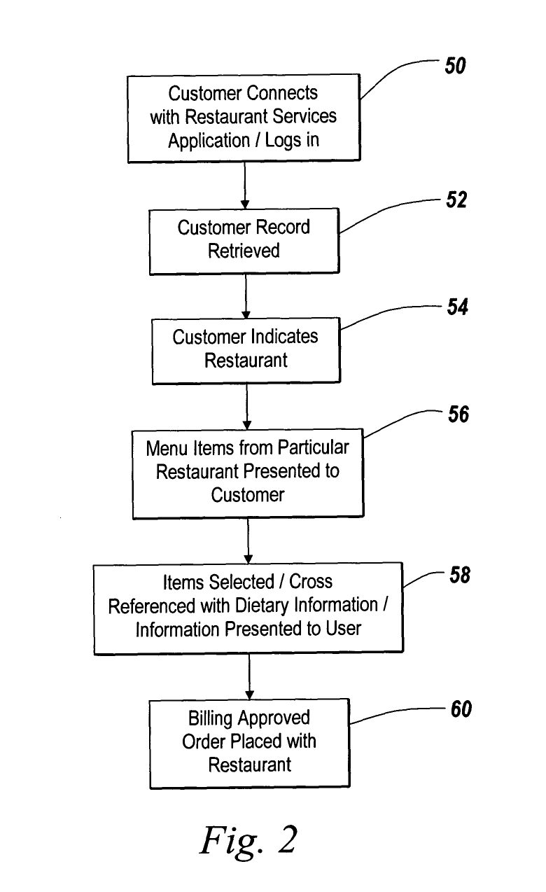

FIG. 2 is a flow chart of the overall sequence of steps followed by the illustrative embodiment of the present invention to accept and process customer orders. The sequence begins when the customer connects with the Restaurant Services Application 14 and logs in using a user ID (step 50). The user ID is contained in a previously stored customer record. The customer record includes an identifier and location, billing information, and may contain dietary restriction information if submitted by the customer previously. The Restaurant Services Application 14 then retrieves the customer record 8 from the storage location (step 52). The customer then indicates a particular restaurant of interest from among others presented by the Restaurant Services Application 14 (step 54). The menu items from the particular restaurant are then presented to the customer (step 56). The customer selects one or more of the available menu items. The menu items are cross-referenced with any dietary restriction information and/or ingredient information and the results are presented to the customer (step 58). Once the billing has been approved using the billing information from the customer record, the order is placed with the restaurant (step 60).

The user interfaces of the illustrative embodiment of the present invention are generated using dynamic HTML (Hyper Text Markup Language). Basic Internet technology simply transmits static HTML pages that exist on the server, across the Internet to the user's computer where a browser on the user's computer displays it. The present invention uses dynamic HTML to create web pages based on the contents of the database records. The displays that are transmitted can change over time as the status of an order changes or the availability of menu items change. Most web page browsers can be used to view the displays. Multiple types of devices can be used to interact with the system, including miniature devices such as PDAs and cell phones.

A Restaurant Manager and Chef Interface is used to create the menus, list the ingredients, and set the price for each menu item. To interact with the inventory control, screens are provided to add or remove items from inventory, set the quantity on hand, adjust the low level alert warning, order additional stock of an item, and receive ordered stock into inventory. Bar code swipe accessories can be used to expedite the entry of new inventory.

A manager or chef begins a session by logging into the server. Once the user name and password matches an entry in the Restaurant Table, a secured and encrypted session is begun.

All records in the tables associated with specified restaurant can be modified. Records associated with other restaurants cannot be seen nor modified.

The first step in building a menu using the Restaurant and Chef Interface is to enter group names in a Group Table, and assign a group number to it. Groups on the menu are displayed from the lowest group number to the highest. For example, most restaurants will have a group named “Appetizer” and make it group number one so that it appears first on the menu. The next step in creating a menu is to add the menu items. Each menu item is given a name, and associated with one of the Groups using a pull-down list that is dynamically created from the Group entries that were created in the first step. A “list number” is entered for each item, which controls where in the group the item will be listed. Items are listed from the lowest number to the highest, providing total control over the way the menu appears. A picture of the item may also be included. Entries may be made into the Options table at the same time the menu items are being created. Options are used to specify a preparation style, such as how a steak is to be cooked, or to select between choices of items. In order to use the calorie and nutrition calculation features of the system, the Inventory and Ingredient tables have to be filled in. In order to use the inventory control features, the Vendors and Inventory-Vendor tables have to be filled in.

Using a computer or device connected to the Internet, customers log into the server to view restaurant menus and place orders. On the first page, a valid user name and password must be entered in order to gain access to the system. If the user does not have an account, they can click the “new account” button to sign up. Once the user name and password matches an entry in the Customer Table, a secured and encrypted session is begun. On the top-level screen, a list of all the restaurants appears. Only the restaurants that can provide service to the user's current location are shown. The user's location is stored in the customer record and is cross-referenced with a specified delivery area for each restaurant. Any restaurant with a delivery area which does not include the indicated location is not shown. The user can click a “personal settings” button to change their location, which would enable them to have food delivered to an alternate location.

After clicking on a restaurant, the menu for the selected restaurant is displayed. The menu is dynamically drawn from the database, with items grouped and listed the way the restaurant manager or chef specified in creating the database entries. The customer clicks on an item to see a full description and a picture. The display of the picture can be disabled via the personal settings button if the Internet connection is slow or a cell phone is being used and display space is limited. Under the description of the item, any options are displayed in the order specified. Single choice options (“select one”) are drawn using a pull down list where the customer can see and click on their choice. Multiple select options (“select multiple”) are drawn in a list where the customer can select an item by clicking on it, at which point the selection becomes highlighted. After all options have been selected, the customer clicks the “Order” button at the bottom and the system generates one or more entries in a temporary “Pending Order Item” array for that single item. The system then reverts back to the menu display. Additional items can be ordered, or the “Order Complete” button can be clicked. After the customer completes the order, the electronic credit card processing in invoked, and if successful, the order is entered into the SQL database. The logic may be represented as follows:

```
Order . order date = current date and time
Order . delivery state = NULL
Order . order state = NULL
Order . cust id = Customer . ID
Order . rest id = Restaurant . ID
Insert Order into database
Current_Order_ID = SQL id generated by previous insert
Estimated Preparation Time = 0
    For Each pending Order Item in the
    array
      Order Item . Prep Time = pending Order Item . Prep Time
      Order Item . Order ID = Current Order ID
      Order Item . Menu Item ID = pending Order Item . Menu Item ID
      Order Item . Item Display = pending Order Item . Item Display
      If Estimated Preparation Time < Item . Prep Time Estimated
        Preparation Time = Item . Prep Time
          (ie, set the Estimated Preparation time to
            the time required for the item requiring
            the most time to prepare)
      End If
      Query database for Menu Item with ID =
      Order Item . Menu Item ID Decrement
      Menu_Item.Quantity_Available
      Insert Order_Item into database
End For each menu item in query result
Order . order state = INITIATE Update
Order record in database
```

The present invention includes a delivery component. A delivery service provider is integrated with the overall system in order to provide delivery services to customers ordering from any of the integrated restaurants. The integration of the delivery service gives every restaurant the ability to offer deliveries without any extra effort on the part of the restaurant. The system offers similar advantages and security to delivery businesses. A delivery business can be established to serve an area without being threatened by the success of a single restaurant, since the system channels business from all restaurants in the area to the delivery business. In addition the system collects payment from the customers using credit card processing, thereby freeing the driver of the responsibility of collecting payments and lessening the threat of being robbed.

An Initiate Delivery Procedure (Order) process is used to initiate the delivery of a customer order. Different actions are taken depending on the type of delivery to be performed. If a waitperson is going to carry the order to a table, no action is taken at this time. If a delivery person is going to transport the order to the customer, then a wireless text message is sent to notify the delivery person of the location where the order is to be picked up and the time when it will be ready. The driver replies to the message with “Answer is Yes” to accept the delivery, or “Answer is No” to decline. These two possible replies may be built into a cell phone making them easy to send. After replying to a message, the cell phone puts the message in the “Outbox” where it stays until deleted. The driver can “Edit” the message and easily send additional replies. When the delivery is completed, the “Yes” is changed and to “Done” and the message is sent again. It takes a minimal number of button presses to change the message and send it again. If the driver receives a “Delivery Late” message, a reply can be sent with the number of minutes needed to complete the delivery.

Other methods of communicating with the drivers are also possible, such as by using a standard voice telephone network. The system permits the placement of a voice call instead of sending text messages, and the touch-tone buttons on the driver's cell phone are used to indicate a response to the system. The system looks up the address using Internet mapping services, and uses the driving time information to estimate the delivery time. The first message sent to the driver shows the delivery address, and if the driver is not familiar with it, the reply to the message can be “Map” and the system will print a small map with the order at the restaurant. Those skilled in the art will recognize that a number of different electronic devices with similar functionality may be substituted for cell phones without departing from the scope of the present invention.

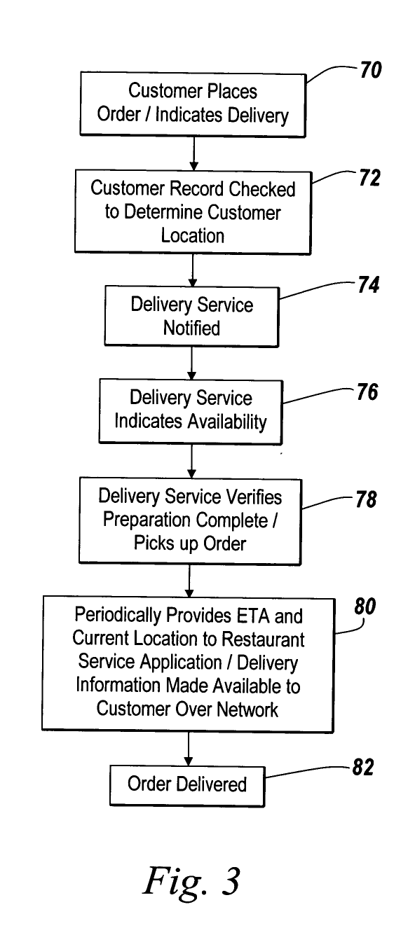

The delivery mechanism is illustrated in the flow chart of FIG. 3. The sequence of steps begins when the customer places an order and indicates that delivery of the order is desired (step 70). The Restaurant Services Application 14 retrieves the customer record 8 to determine the indicated customer location (step 72). If the customer is in an area in which delivery service is available, the delivery service is notified (step 74). It should be noted that the customer may alter the stored location contained in the account record. This flexibility allows customers to order when away from home. Once the delivery service has indicated its availability to make the delivery (step 76) the delivery service verifies that the preparation of the order is complete and/or the current status of the preparation. Once the order is complete the order is picked up by the delivery service (step 78). Following the delivery service picking up the order from the preparing restaurant, the delivery service will provide an estimated time of delivery which is periodically updated and sent to the Restaurant Services Application 14. The delivery information provided by the delivery service provider is made accessible to the customer over the network 2 (step 80). The process completes with the delivery of the order to the customer (step 82). Those skilled in the art will recognize that the delivery service may consist of a single person and that restaurants may also provide their own delivery service in addition to, or instead of, the centralized multiple restaurant coverage-type delivery service described herein.

The kitchen interface may be an industrial strength touch screen that displays all the orders from the database that have a status greater or equal to “Initiate” but less than “Ready”. A graphical icon is displayed to the left of each order, which indicates the order status. The icon flashes if the order needs some kind of attention, such as being acknowledged or late. The chef or cook touches the icon to control the state of the item. The appropriate controls then display on the screen. A numeric keypad displays and is used to adjust the preparation time as needed. Another button can be pressed to indicate the order is “Ready” for delivery. The operator also has the ability to change the quantity still available of each item. Those skilled in the art will recognize that there are a number of different ways to display or convey information in the kitchen to and from the cook.

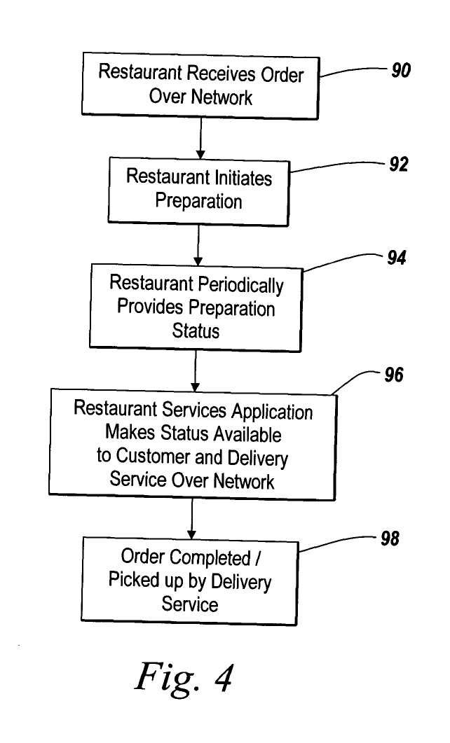

The sequence of steps followed by the restaurants 20, 22, 24, and 26, to process the orders is illustrated by the flow chart of FIG. 4. The sequence begins when the restaurant receives the order over the network from the Restaurant Services Application 14 (step 90). The order includes the menu items selected by the customer 32, 34 and 36. The restaurant initiates preparation of the selected menu items (step 92) and periodically updates the preparation status of the various ordered menu items (step 94). The updated status is provided to the Restaurant Services Application 14 which makes the status available to the customer and the delivery service over the network (step 96). The preparation status information is provided to the delivery service 30 so that the delivery service knows when to pick up the order from the restaurant, and it is provided to the customer to satisfy the customers curiosity. Upon order completion, the order is picked up by the delivery service 30 (step 98).

As mentioned earlier, the illustrative embodiment of the present invention may include a Shadow Device 21, 23, 25 and 27 mirroring the data from the electronic device 6. A Control Task runs continuously on both the primary electronic device 6 and the shadow devices 21, 23, 25, and 27. The primary electronic device 6 performs the operations required by the illustrative embodiment of the present invention, but the shadow electronic device 21, 23, 25 and 27 monitors the primary electronic device 6 to verify it is operating correctly. Assuming the electronic device 6 is operating correctly, the control task running on the primary electronic device processes the orders. The algorithm maybe represented as follows:

```
Do Forever
    Wait until time for next control cycle
    Server Coordination between Primary & Shadow
    If Server Role is Primary
        Process Orders
    End If
End Do Forever
```

This Control Task communicates through a reserved socket with the same process on partner systems to make sure they are operating normally. If the primary system finds that a shadow system is not successfully mirroring the SQL database, or is having communication problems, then the primary reports the problem to maintenance. If a shadow machine determines a problem exists with the primary machine, the shadow reports the problem to maintenance and then takes over as primary. When more than one shadow machine exists, there is a configurable set of rules used to determine which machine will take over as primary. When a restaurant is using this system for its local operations, a shadow server can exist in restaurant itself. This allows operation to continue in the event that the Internet connection is lost.

After an Order Entry Module writes orders to the SQL database, the control task is responsible for advancing the state of each order from the initial state to the completed state. Each time the state is advanced, an associated action is taken. The algorithm may be represented as follows:

```
Query the database for Orders where State != completed
For Each Order in Query results
    Switch on Order.State
    Case Initiate :
        (Note: waiting for kitchen to acknowledge the order)
        If Current Time > Order . Deadline Time
            If NOT Order . Problem Reported
                Call Problem Report Procedure(Order)
            End If
        End If
    End Case
    Case Preparation Acknowledged :
        (Note: kitchen has acknowledged the order and possibly
        changed the time it will take to prepare)
        Order.Deadline Time = Current Time + Order.Preparation Time
        Call Delivery Initiate Procedure(Order)
        Order.State = Preparing
    End Case
    Case Preparing :
        If Current Time > Order . Deadline Time
          Order.State = Preparation Late
        End If
    End Case
    Case Preparation Late :
        If Current Time >Order.Deadline Time + Preparation Time
        Allowance
            If NOT Order . Problem Reported
                Call Problem Report Procedure(Order)
            End If
        End If
    End Case
    Case Ready :
      (Note: the kitchen has marked the order as ready for delivery)
        Order.State = Delivering
        Order.Deadline Time = Current Time + Order.Maximum
        Delivery Time
    End Case
    Case Delivering :
        If Current Time > Order . Deadline_Time
            Order State = Delivery Date
            SendDeliveryLateMessage(Order)
        End If
    End Case
    Case Delivery Late :
      (Note: a message from the driver can cause the deadline time to be
        be extended)
        If Current Time > Order.Deadline Time + Delivery
        Time Allowance
            If NOT Order . Problem Reported
                Call Problem Report Procedure(Order)
            End If
        End If
    End Case
  End Switch on order state
End For Each query result
```

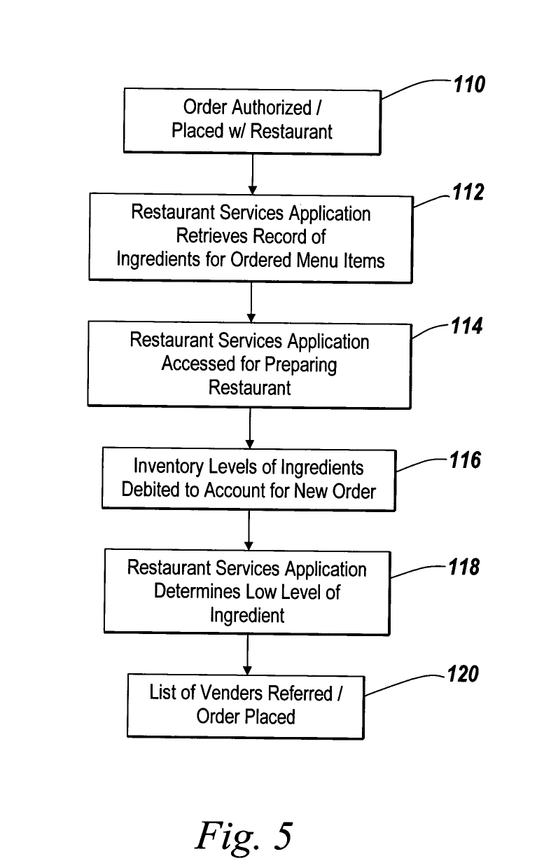

The various restaurants 20, 22, 24, and 26 keep track of an inventory of menu ingredients that are needed to prepare the various menu items offered for sale. The inventory 12 is typically stored in a database format and is accessible to the Restaurant Services Application 14. FIG. 5 depicts the sequence of steps followed by the illustrative embodiment of the present invention to programmatically update the various inventories in response to ordered menu items. The sequence begins when an order is authorized and placed with a particular restaurant (step 110). The Restaurant Services Application 14 retrieves the record of ingredients for the ordered menu items (step 112). The record of ingredients is provided by the restaurants (20, 22, 24, and 26) when they post the available menu items being offered for sale. The Restaurant Services Application 14 then accesses the inventory for the preparing restaurant 20, 22, 24, and 26. The amounts of the ingredient used to the make the selected menu items are then subtracted from the existing inventory levels stored in the database or other format to account for the new order (step 116). The Restaurant Services Application 14 may also programmatically monitor the inventory 12 such that inventory levels of various ingredients are compared against pre-determined parameters. Upon an inventory ingredient dropping below a pre-determined parameter, as determined by the Restaurant Services Application (step 118), a list of vendors providing the particular ingredient to that particular restaurant is retrieved. A replacement order for ingredients may then be programmatically placed with the vendor, or a notification, accompanied by an indication of the vendor(s) availability, may be forwarded to the particular restaurant depending upon the implementation (step 120). Those skilled in the art will recognize that the inventory tracking system may also be set up to include other inventory depleting actions such as the food preparation activity that typically takes place in a restaurant in advance of any actual orders. For example, the preparation of dinner salads in advance of the dinner hour.

Since certain changes may be made without departing from the scope of the present invention, it is intended that all matter contained in the above description or shown in the accompanying drawings be interpreted as illustrative and not in a literal sense. Practitioners of the art will realize that the sequence of steps and architectures depicted in the figures may be altered without departing from the scope of the present invention and that the illustrations contained herein are singular examples of a multitude of possible depictions of the present invention.

1. In a network, a method for managing the delivery of restaurant related services from a plurality of unaffiliated restaurants, comprising the steps of:
storing at least one customer record at a location accessible over said network, said customer record including a customer identifier and at least one of dietary restriction information, billing information and customer location information;
storing a plurality of menu item records at a location accessible over the network, said menu items associated with a particular restaurant and available for purchase over said network;
enabling access to a presentation of said menu items over said network to a customer, said customer being associated with at least one of said stored customer records; and
providing an inventory of ingredients needed to make said menu items, said inventory stored at a location accessible over said network.

2. The method of claim 1, comprising the further step of:
accepting menu selections from said customer, said selection using said customer record.

3. The method of claim 2, comprising the further steps of:
providing a delivery service for more than one of said plurality of restaurants, said delivery service accessing delivery information over said network prior to delivering the selected menu items to the ordering customer.

4. The method of claim 3, comprising the further step of:
providing updated delivery status information from the delivery service over said network to the ordering customer.

5. The method of claim 2, comprising the further steps of:
providing updated information regarding the preparation status of said selected menu items to the ordering customer over said network.

6. The method of claim 5, comprising the further steps of:
providing said updated preparation status information to said delivery service over said network.

7. The method of claim 2, comprising the further step of:
programmatically updating the inventory of ingredients to reflect the items used in the preparation of said selected menu items.

8. The method of claim 7, comprising the further step of:
storing records of at least one vendor available to sell ingredients used in said selected menu items.

9. The method of claim 8, comprising the further step of:
programmatically placing an order from said at least one of said vendor in response to a diminished level of a menu item ingredient.

10. The method of claim 1 wherein said menu items are associated with preparation options chosen by authorized individuals at the restaurant associated with said menu items.

11. The method of claim 10 wherein said preparation options include at least one of cooking time options and additional ingredient options.

12. The method of claim 1, comprising the further steps of:
providing at a location accessible to at least one of said plurality of restaurants, a shadow electronic device, said shadow electronic device storing current copies of said customer records, plurality of menu item records associated with said at least one of said plurality of restaurants, the inventory of ingredients and said menu selections; and
using said shadow electronic device to deliver restaurant services to customers of said at least one restaurant in the event of a disruption in said network.

13. The method of claim 1 wherein access to the presentation of said menu items is limited based upon the location of the customer.

14. In a network, a restaurant services delivery system, comprising:
a plurality of restaurants not associated with each other, said restaurants connected to the network and producing electronic versions of menu items available for purchase from said restaurant; and
an electronic device interfaced with said network, said electronic device having access to at least one storage location on said network holding at least one customer record, said customer record including a customer identifier, billing information and at least one of dietary restriction information and customer location information, and a plurality of said electronic versions of menu items, said electronic device enabling access to a customer associated with a customer record, said customer selecting and purchasing at least one of said menu items using said billing information.

15. The system of claim 14 wherein said electronic device also has access to a location holding an inventory of ingredients needed to make said menu items available from one of said restaurants, said inventory being programmatically updated to reflect ingredients used in preparing said customer selections.

16. The system of claim 14, further comprising:
a delivery service, said delivery service having access to said network and delivering orders for customers of said restaurants.

17. The system of claim 16 wherein said delivery service uses said customer location information to deliver the customer selections.

18. The system of claim 14 wherein said electronic version of said menu items includes dietary information.

19. The system of claim 14 wherein said dietary restriction information is cross-referenced with said customer selection and a warning displayed to said customer regarding ingredients from said dietary restriction information that are present in said customer selection.

20. In a network, a medium holding computer-executable steps for a method for managing the delivery of restaurant related services from a plurality of unaffiliated restaurants, said method comprising the steps of:
storing at least one customer record at a location accessible over said network, said customer record including a customer identifier and at least one of dietary restriction information, billing information and customer location information;
storing a plurality of menu item records at a location accessible over the network, said menu items associated with a particular restaurant and available for purchase over said network;
enabling access to a presentation of said menu items over said network to a customer, said customer being associated with at least one of said stored customer records; and
providing an inventory of ingredients needed to make said menu items, said inventory stored at a location accessible over said network.

21. The medium of claim 20, wherein said method comprises the further step of:
accepting menu selections from said customer, said selection using said customer record.

22. The medium of claim 21, wherein said method comprises the further step of:
providing a delivery service for more than one of said plurality of restaurants, said delivery service accessing delivery information over said network prior to delivering the selected menu items to the ordering customer.

23. The medium of claim 22, wherein said method comprises the further step of:
providing updated delivery status information from the delivery service over said network to the ordering customer.

24. The medium of claim 21 wherein said method comprises the further step of:
providing updated information regarding the preparation status of said selected menu items to the ordering customer over said network.

25. The medium of claim 24 wherein said method comprises the further step of:
providing said updated preparation status information to said delivery service over said network.

26. The medium of claim 21 wherein said method comprises the further step of:
programmatically updating the inventory of ingredients to reflect the items used in the preparation of said selected menu items.

27. The medium of claim 26 wherein said method comprises the further step of:
storing records of at least one vendor available to sell ingredients used in said selected menu items.

28. The medium of claim 27 wherein said method comprises the further step of:
programmatically placing an order from said at least one of said vendor in response to a diminished level of a menu item ingredient.

29. The medium of claim 20 wherein said menu items are associated with preparation options chosen by authorized individuals at the restaurant associated with said menu items.

30. The medium of claim 29 wherein said preparation options include at least one of cooking time options and additional ingredient options.

31. The medium of claim 20, wherein said method comprises the further steps of:
providing at a location accessible to at least one of said plurality of restaurants, a shadow electronic device, said shadow electronic device storing current copies of said customer records, plurality of menu item records associated with said at least one of said plurality of restaurants, the inventory of ingredients and said menu selections; and
using said shadow electronic device to deliver restaurant services to customers of said at least one restaurant in the event of a disruption in said network.

32. In a network, a method for managing the delivery of restaurant related services from a plurality of restaurants, comprising the steps of:
storing at least one customer record at a location accessible over said network, said customer record including a customer identifier and at least one of dietary restriction information, billing information and customer location information;
storing a plurality of menu item records at a location accessible over the network, said menu items associated with a particular restaurant and available for purchase over said network;
enabling access to a presentation of said menu items over said network to a customer, said customer being associated with at least one of said stored customer records; and
providing an inventory of ingredients needed to make said menu items, said inventory stored at a location accessible over said network.

33. The method of claim 32, comprising the further step of:
accepting menu selections from said customer, said selection using said customer record.

34. The method of claim 33, comprising the further steps of:
providing a delivery service for more than one of said plurality of restaurants, said delivery service accessing delivery information over said network prior to delivering the selected menu items to the ordering customer.

35. The method of claim 34, comprising the further step of:
providing updated delivery status information from the delivery service over said network to the ordering customer.

36. The method of claim 33, comprising the further steps of:
providing updated information regarding the preparation status of said selected menu items to the ordering customer over said network.

37. The method of claim 36, comprising the further steps of:
providing said updated preparation status information to said delivery service over said network.

38. The method of claim 33, comprising the further step of:
programmatically updating the inventory of ingredients to reflect the items used in the preparation of said selected menu items.

39. The method of claim 38, comprising the further step of:
storing records of at least one vendor available to sell ingredients used in said selected menu items.

40. The method of claim 39, comprising the further step of:
programmatically placing an order from said at least one of said vendor in response to a diminished level of a menu item ingredient.

41. The method of claim 32 wherein said menu items are associated with preparation options chosen by authorized individuals at the restaurant associated with said menu items.

42. The method of claim 41 wherein said preparation options include at least one of cooking time options and additional ingredient options.

43. The method of claim 32, comprising the further steps of:
providing at a location accessible to at least one of said plurality of restaurants, a shadow electronic device, said shadow electronic device storing current copies of said customer records, plurality of menu item records associated with said at least one of said plurality of restaurants, the inventory of ingredients and said menu selections; and
using said shadow electronic device to deliver restaurant services to customers of said at least one restaurant in the event of a disruption in said network.

44. The method of claim 32 wherein access to the presentation of said menu items is limited based upon the location of the customer.
